(19) United States
(12) Patent Application Publication
(10) Pub. No.: US 2009/0203522 A1
(43) Pub. Date: Aug. 13, 2009

(54) PRINTABLE IDENTIFICATION MEDIUM FOR USE WITH THERMAL PRINTERS

(75) Inventor: Edward D. Hammerslag, Thousand Oaks, CA (US)

Correspondence Address: KELLY LOWRY & KELLEY, LLP, 6320 CANOGA AVENUE, SUITE 1650, WOODLAND HILLS, CA, 91367, US

(73) Assignee: PRECISION DYNAMICS CORPORATION, San Fernando, CA (US)

(21) Appl. No.: 12/029,060

(22) Filed: Feb. 11, 2008

(51) Int. Cl. B41M 5/40; B41M 3/00

(52) U.S. Cl. 503/204; 428/32.63; 427/146

(57) ABSTRACT

An identification device in the form of a wristband, labels or cards, including a thermal sensitive coating laminated between a clear plastic coating and a liner ply. The clear plastic coating including UV inhibitors or anti-oxidants protects the thermal sensitive coating from damage by environmental hazards. The clear plastic coating also allows for reliable thermal printing on the thermal sensitive coating with the clear plastic coating in place.

### BACKGROUND OF THE INVENTION

This invention relates generally to printable identification media, namely, wristbands, labels and cards. More specifically, this invention relates to such media having a thermal sensitive coating and a protective transparent coating.

Current identification devices having thermal sensitive coatings place the thermal coating as a top layer of several layers so that the thermal coating is easily activated with thermal printheads. Some prior art devices provide a protective layer including a coating or varnish to protect the thermal layer from damage by solvents or other materials. Such varnishes are cured by ultraviolet light, can result in varying thickness following manufacture, and can result in a darker image. The darker image results because the thermal sensitive coating is not a fixed distance from the thermal print head due to the varying thickness of the varnish. This variation in distance results in a thermal sensitive coating with a greater degree of activation in areas where the over coat varnish is thinner and a lesser degree of activation in areas where the over coat varnish is thicker. Such varnishes are also soluble in certain chemicals, hand sanitizers and alcohols found in environments such as hospitals, bars, etc.

Such coatings or varnishes are problematic due to manufacturing inconsistencies such as coating thicknesses, chemical reactions with liquids that the final product may come into contact with and inconsistencies in the chemical makeup of the coating. Such issues are of greater concern to users of the products in environments where the device may come into contact with potentially damaging compounds. In one environment, healthcare facilities, the identification device may be exposed to alcohol, creams and/or gels that are harmful to the thermal or varnish layer. Another example of a harsh environment is water parks where chemicals like chlorine and exposure to harmful UV rays are present and can damage the thermal layer. The exposure to UV light and oxygen reduces the print quality and causes the print to “fade” prematurely. This is a critical problem with direct thermal printed cards, labels and wristbands.

Therefore, there is a need for an identification device having a thermally activated layer that is adequately protected from harsh environments both chemical and ultraviolet. Further, there is a need for an improved coating or varnish for such thermally activated layers that will protect them from solvents or chemicals that may be used in those environments. The present invention fulfills these needs and provides other related advantages.

### SUMMARY OF THE INVENTION

The present invention resides in a printable identification medium for use with thermal printers. The identification medium comprises a flexible base substrate, a thermal activation layer made from a thermal sensitive coating overlying the flexible base substrate, and a transparent substrate sheet overlying the thermal activation layer. The flexible base substrate may comprise a mono-, bi-, or tri-laminate material. Further, the flexible base substrate may be impregnated with colored ink or may receive printed matter on an exposed surface. Another embodiment would be that the thermal sensitive layer could be bonded directly to the clear transparent layer thus eliminating the inconsistencies associated with the adhesive layer over the thermal sensitive material.

In an alternate embodiment the identification medium may include a first adhesive layer between the flexible base substrate and the thermal activation layer. The identification medium may also include a second adhesive layer between the thermal activation layer and the transparent substrate sheet. In the absence of either adhesive layer the thermal activation layer may be combined with an adhesive prior to being applied to the flexible base substrate. The adhesive or adhesive layers may comprise an ultraviolet adhesive or a pressure-sensitive adhesive. Where an adhesive is not used in the identification medium the transparent substrate sheet should be laminated to the flexible base substrate in such a way as to maintain the thermal activation layer therebetween. Preferably the thermal activation layer will be bonded directly to the clear transparent substrate sheet.

The transparent substrate sheet comprises a polymer film of uniform thickness. The polymer film preferably comprises polyester or polyethylene terephthalate. In its most preferred embodiment the transparent substrate sheet comprises polyethylene terephthalate having a uniform thickness between 0.5 mm and 1.0 mm. This transparent substrate sheet may be impregnated with UV inhibitors and/or anti-oxidants to reduce the effect of ultra violet light and oxidation on the thermal layer.

The identification medium comprises a wristband, a label, or a card. A thermal printer may cause the thermal activation layer to print letters, numbers, characters or symbols. Further, the thermal activation layer may be configured to print different colors depending on the type of thermal sensitive coating comprising the layer or energy signal produced by the thermal printer.

The present invention also resides in a process for manufacturing a printable identification medium for use with thermal printers. The process begins with providing a flexible base substrate. A thermal activation layer is then adhered to the flexible base substrate. Finally, a transparent substrate sheet overlies the thermal activation layer. As described above, an adhesive layer may be applied to the flexible base substrate before adhering the thermal activation layer. Such adhesive layer may comprise an ultraviolet adhesive or a pressure-sensitive adhesive. Alternatively, an adhesive may be mixed with the thermal activation layer before adhering same to the flexible base substrate. Also the thermal activation layer could be bonded directly on the under side of the transparent substrate sheet to eliminate the inconsistencies of the adhesive layer. With this embodiment, the thermal activation layer will always be a fixed distance from the print head and will eliminate manufacturing inconsistencies

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a cross-sectional view of an identification device embodying the present invention showing the separate layers;

FIG. 2 is a perspective view of a wristband embodying the present invention;

FIG. 3 is a perspective view of a sheet of labels embodying the present invention; and

FIG. 4 is a cross-sectional view of a thermal printhead activating the thermal layer of an identification device embodying the present invention.

### DETAILED DESCRIPTION OF THE PREFERRED EMBODIMENTS

The present invention is concerned with a printable identification medium for use with thermal printers. More specifically, the present invention is directed to identification wristbands, labels or cards that are capable of being printed with the use of a thermal printer and have a protective coating to guard against damage by environmental hazards.

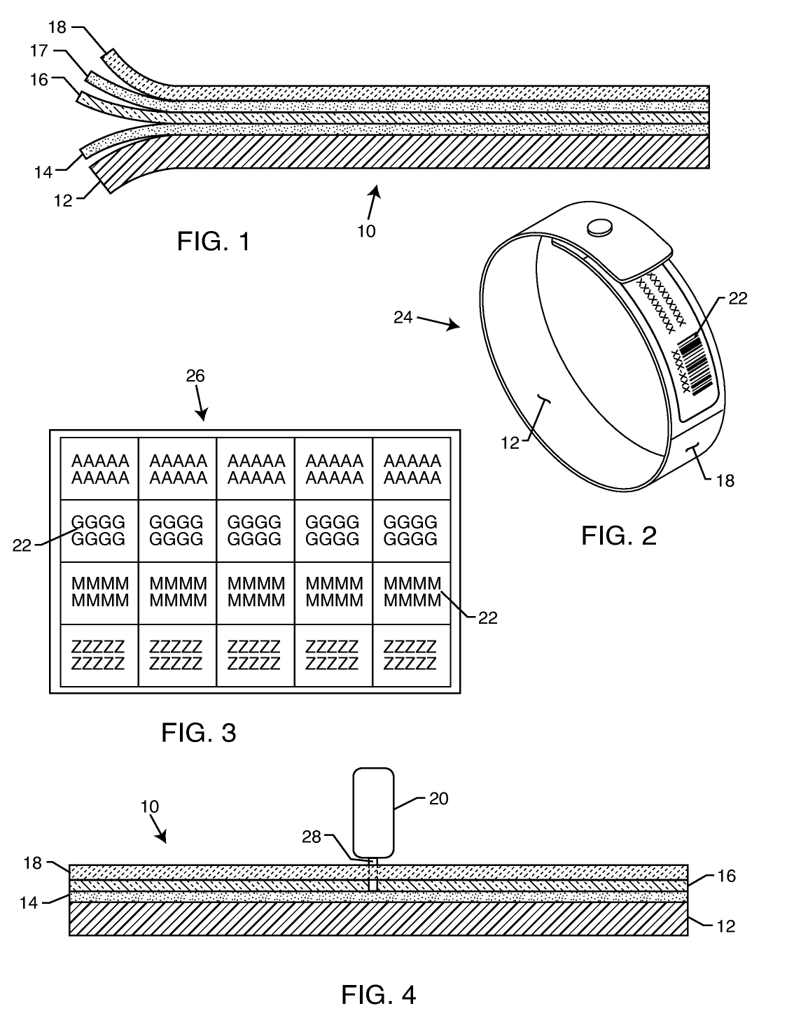

FIG. 1 depicts a cross-sectional view of an identification medium 10 of the present invention. This embodiment shows four layers laminated together—a flexible base substrate or liner layer 12, a first adhesive layer 14, a thermal activation layer 16, a second adhesive layer 17 and a transparent substrate sheet 18. As described further below, either or both adhesive layers 14, 17 may be omitted or blended with the thermal activation layer 16.

The flexible base substrate or liner layer 12 is made from any flexible, durable film or polymer commonly used in similar identification devices. Preferably, the liner layer 12 is comprised of a mono-, bi- or tri-laminate film. The material that comprises the liner layer 12 may be impregnated with colored ink or may receive printed matter on an exposed surface.

The first adhesive layer 14 adheres the liner layer 12 to the thermal activation layer 16. The second adhesive layer 17 adheres the thermal activation layer 16 to the transparent substrate sheet 18. Such adhesive layers 14, 17 may be a pressure sensitive, ultraviolet, or other commonly used adhesive. The selected adhesive must be one that will not be damaged or otherwise impaired by the heat from the thermal printer.

As discussed above, the first adhesive layer 14 or second adhesive layer 17 may be omitted from the identification device. The reason for eliminating either adhesive layer 14, 17 would be to avoid a manufacturing step or eliminate inconsistencies. If either adhesive layer 14, 17 is omitted, then the lamination of the liner layer 12 to the transparent substrate sheet 18 should be of sufficient strength and durability to maintain the thermal activation layer 16 therebetween.

Alternatively, the thermal activation layer 16 may be combined with an adhesive prior to application to the liner layer 12. In this manner, the activation layer 16 self-adheres to the liner layer 12 and transparent substrate sheet 18 without the need for a separate adhesive layer 14, 17.

The thermal activation layer 16 can be made from any thermal sensitive coating used with thermal printers. The thermal activation layer 16 needs to be capable of activation by a thermal printer print head 20 to receive printed information 22. Once activated, the effect of the thermal activation layer 16 may vary. In the most basic embodiment, the thermal activation layer 16 may print black letters, numbers, characters or symbols according to the signals sent to the thermal printer. Alternatively, the thermal activation layer 16 may be designed to print different colors according to the type of thermal sensitive coating or energy signal produced by the thermal printer.

The transparent substrate sheet 18 is preferably polyester, polyethylene terephthalate (PET) or other strong, thin film. The transparent substrate sheet 18 of the present invention should be of uniform thickness, assuring that the thermal activation layer 16 is a known fixed distance from the print head over its entire length. This uniformity of thickness in the transparent substrate sheet 18 results in more consistent activation of the thermal activation layer 16 along its length. The transparent substrate sheet 18 is resistant to the chemical and solvents found in the harsh environments discussed above. The transparent substrate sheet 18 could also be impregnated with ultra-violet (UV) inhibitors and/or anti-oxidants to reduce exposure of the thermal activation layer 16 to harmful UV light sources and oxidation. This will have the effect of longer lasting printed information 22.

In a preferred embodiment, the transparent substrate sheet 18 is PET between 0.5 millimeters and 1.0 millimeters thick. This thickness of PET provides sufficient protection of the thermal activation layer 16 against environmental hazards while producing consistent print results.

FIGS. 2 and 3 depict perspective views of a wristband 24 and a sheet of labels 26 respectively, each embodying the present invention. FIG. 4 illustrates a print head 20 from a thermal printer (not shown) activating the thermal activation layer 16 of an identification device 10 embodying the present invention. As illustrated, the energy 28 from the thermal print head 20 passes through the transparent substrate sheet 18 and activates the thermal activation layer 16.

Although particular embodiments of the invention have been described in detail for purposes of illustration, various modifications may be made without departing from the scope and spirit of the invention. Accordingly, the invention is not to be limited, except as by the appended claims.

What is claimed is:

1. A printable identification medium for use with thermal printers, comprising:
a flexible base substrate;
a thermal activation layer comprising a thermal sensitive coating overlying the flexible base substrate; and
a transparent substrate sheet overlying the thermal activation layer.

2. The printable identification medium of claim 1, wherein the flexible base substrate comprises a mono-laminate, bi-laminate or tri-laminate material.

3. The printable identification medium of claim 1, further comprising a first adhesive layer between the flexible base substrate and the thermal activation layer.

4. The printable identification medium of claim 3, wherein the first adhesive layer comprises an ultraviolet adhesive or a pressure-sensitive adhesive.

5. The printable identification medium of claim 1, further comprising a second adhesive layer between the thermal activation layer and the transparent substrate sheet.

6. The printable identification medium of claim 5, wherein the second adhesive layer comprises an ultraviolet adhesive or a pressure-sensitive adhesive.

7. The printable identification medium of claim 1, wherein the identification medium comprises a wristband, a label, or a card.

8. The printable identification medium of claim 1, wherein the transparent substrate sheet comprises a polymer film.

9. The printable identification medium of claim 8, wherein the polymer film comprises polyester or polyethylene terephthalate.

10. The printable identification medium of claim 9, wherein the transparent substrate sheet comprises polyethylene terephthalate having a thickness between 0.5 mm and 1.0 mm.

11. The printable identification medium of claim 1, wherein the flexible base substrate is impregnated with colored ink or receives printed matter on an exposed surface.

12. The printable identification medium of claim 1, wherein the transparent substrate sheet is laminated to the flexible base substrate such that the thermal activation layer is maintained therebetween.

13. The printable identification medium of claim 1, wherein the thermal activation layer self-adheres to the flexible base substrate.

14. The printable identification medium of claim 1, wherein the thermal activation layer prints different colors depending upon the type of thermal sensitive coating comprising the layer or energy signal produced by the thermal printer.

15. The printable identification medium of claim 1, wherein the transparent substrate sheet is of uniform thickness.

16. The printable identification medium of claim 1, wherein the transparent substrate sheet includes ultra-violet inhibitors or anti-oxidants.

17. A process for manufacturing a printable identification medium for use with thermal printers, comprising the steps of:
providing a flexible base substrate;
adhering a thermal activation layer to the flexible base substrate; and
overlaying a transparent substrate sheet on the thermal activation layer.

18. The process of claim 17, further comprising the step of applying an adhesive layer to the flexible base substrate before the adhering step.

19. The process of claim 18, wherein the adhesive layer comprises an ultraviolet adhesive or a pressure-sensitive adhesive.

20. The process of claim 17, further comprising the step of mixing an adhesive with the thermal activation layer before the adhering step.

21. The process of claim 17, wherein the flexible base substrate comprises a mono-laminate, bi-laminate or tri-laminate material.

22. The process of claim 17, wherein the identification medium comprises a wristband, a label or a card.

23. The process of claim 17, wherein the transparent substrate sheet comprises a polymer film.

24. The process of claim 17, wherein the polymer film comprises polyester or polyethylene terephthalate.

25. The process of claim 24, wherein the polymer film comprises polyethylene terephthalate having a thickness between 0.5 mm and 1.0 mm inclusive.

26. The process of claim 17, wherein the transparent substrate sheet is of uniform thickness.
